(19) United States
(12) Patent Application Publication
(10) Pub. No.: US 2025/0356706 A1
(43) Pub. Date: Nov. 20, 2025

(54) SECURE AREA DOOR SAFETY SYSTEM

(71) Applicant: ONES BILISIM TEKNOLOJILER ANONIM SIRKETI, Ankara (TR)

(72) Inventors: Dursun Dogukan GOZEN, Ankara (TR); Engin CAN, Ankara (TR); Gucluhan KUZYAKA, Ankara (TR); Gurol Erkin GURBUZ, Ankara (TR); Onur SIRMATEL, Ankara (TR)

(73) Assignee: ONES BILISIM TEKNOLOJILER ANONIM SIRKETI, Ankara (TR)

(21) Appl. No.: 18/871,524

(22) PCT Filed: Jun. 2, 2023
(86) PCT No.: PCT/TR2023/050517

§ 371 Date: Dec. 4, 2024

(30) Foreign Application Priority Data
Jun. 6, 2022 (TR) 2022/009324

(51) Int. Cl. G07C 9/00; H04L 9/40

(52) U.S. Cl. CPC G07C 9/00563; H04L 63/0861

(57) ABSTRACT

A safety system relates to the development of door safety for accessing secure rooms/areas, wherein the entry of users is realized by means of a pair of control units located in the unsecured area and the secure area. The input module consists of a scanner, a display, a speaker, a microphone, and a camera. The control module contains a controller.

### CROSS REFERENCE TO THE RELATED APPLICATIONS

This application is the national phase entry of International Application No. PCT/TR2023/050517, filed on Jun. 2, 2023, which is based upon and claims priority to Turkish Patent Application No. 2022/009324, filed on Jun. 6, 2022, the entire contents of which are incorporated herein by reference.

### TECHNICAL FIELD

The present invention relates to the development of door safety for accessing secure rooms/areas, wherein the entry of users is realized by means of a pair of control units located in the unsecured area and the secure area.

### BACKGROUND

Information and data have constantly maintained their importance from tribal formations to the present day, both verbally and in writing. In fact, serious measures have been taken at this point in recent years. This data, which should be protected, may belong to government information or companies. Protection of information and documents that are trade secrets within the companies as well as employees' information in their personal data can lead to serious sanctions in case of violations.

Measures are expected to be taken in the context of the “Need to Know Basis”, which is the basic intelligence rule emphasized especially in the defense industry regulation. In order to protect the company data of the companies, it makes authorizations according to the position of the employee. In this context, companies provide access to the relevant unit with the data, biometric data, or encrypted entry methods included in the card in order to enable users to work only in authorized areas. However, malicious violations may occur in these systems if security is not received well. For this reason, many different techniques are used to increase the security level of such systems and to make system improvements.

To briefly summarize the most well-known of the breaches and the system that creates the biggest vulnerability;
The security hardware that makes the password, card, or biometric prepaid stands in a physically unsecured area,
The user opens the door by scanning their own password, card, or biometric data to the hardware.
The system that unlocks or drives the door's motor to open the door waits for the appropriate direct current electrical signal.
The equipment located in the unsecured area supplies the direct current electricity to the unlocking line after completing the verification of the correctness of the relevant direct current electrical signal password/card/biometric data.
The fact that an unauthorized user is usually in the current electrical supply to the green and black cable line through a 9V battery that they carry with them to the door opening circuit by breaking the electronic equipment in the unsecured area with the physical intervention will often enable the door to be opened.

A dual or progressive access level safety system and method is described in the United States patent document U.S. Pat. No. 10,062,224B2, which is one of the embodiments in the state of the art. The system receives one or more initial access identifiers of the user via an identity reader. For example, the identity reader is an antenna, such as a biometric scanner, such as a fingerprint scanner, or a Near Field Communication (NFC) antenna, which reads the initial access identifier from a tag within a user device, such as a fob. In addition, a Bluetooth identifier may be used from the mobile phone or the user's mobile computing device. In response to the authentication of the initial access identifier, the system provides virtual keys for the user to enter an access code. The virtual keys for editing are located on a touchscreen and in a virtual projected keyboard provided by the safety system. The safety system grants access to the user in response to the verification of the access code. With the method used in this system, the user logs into the system by performing the verification on a server. However, there is no mention of double verification as a security verification step in the system restart or installation of the safety system.

The invention, the subject of the Chinese utility model application numbered CN206649881U, which is another embodiment of the state of the art, describes a security protection system and computer security method together with a computer access control system. This computer access control system includes the service terminal, the user terminal, and the access control system. The user terminal and service end communication link for sending positioning information to the service end includes the service end and access control system communication link for sending dynamic authentication information to the access control system according to the positioning information. The access-control system receives the respective authentication information that processes the dynamic authentication information to process accordingly and sends an on or off-control command with the control gate using that authentication information. The utility model describes the location information of a combination user terminal and the dual verification mode of dynamic verification information, security that can effectively improve the access control system. When the details of the art used are examined, it is mentioned that verification information is carried out on a server. However, in this art, there is no mention of a precaution for users to establish the system safely and to ensure security during the first identification of the system.

Finally, the invention, the subject of the Chinese patent application numbered CN106683249A, which is one of the embodiments in the state of the art, includes the technical field of door access security and in particular a bank door access safety system based on the Internet of Things (IoT). It includes a bank door access safety system, a bank security center, a cash register door access system, and a cash register safety system. Here, the vault door access system and the vault safety system are both connected to the bank security center. The vault safety system consists of a vault fingerprint door access safety system, a vault channel double-door access control system, and a vault voice door access system. The opposite door access system includes a control host, a display, a power source, a keyboard adapter, a first fingerprint instrument, and a plurality of cameras. The power supply is used to power the control host, display, keyboard adapter, first fingerprint instrument, and most of the cameras, respectively. The screen, keyboard adapter, first fingerprint instrument, and most of the cameras are connected to the control host. As in the other known technical examples, there is no mention of a two-stage system start-up operation depending on the customization of the system in a certain area in this application.

### SUMMARY

The object of this invention is to develop a secure area door safety system that allows the authorities to open the lock from the secure area after providing the desired input protocol in the unsecured area/region.

Another object of the invention is to develop a secure area door safety system that includes control and management units in the secure area in order to prevent any violation of the system in the unsecured area/region.

Another object of the invention is to develop a secure area door safety system that can communicate with the control and management units in the safe zone in encrypted form.

Another object of the invention is to develop a secure area door safety system to verify safe and unsecured areas during system activation and restart operations.

### BRIEF DESCRIPTION OF THE DRAWINGS

The figures and related descriptions used to better explain the secure area door safety system developed by the invention are as follows.

FIG. 1 is a schematic view of the secure area door safety system according to the invention from the unsecured area side.

FIG. 2 is a schematic view of the secure area door safety system according to the invention from the secure area side.

FIG. 3 is a perspective view of the input module of the secure area door safety system according to the invention.

FIG. 4 is a perspective view of the control module of the secure area door safety system according to the invention.

FIG. 5 is a schematic view of the unlocking flow algorithm of the safe space door safety system according to the invention.

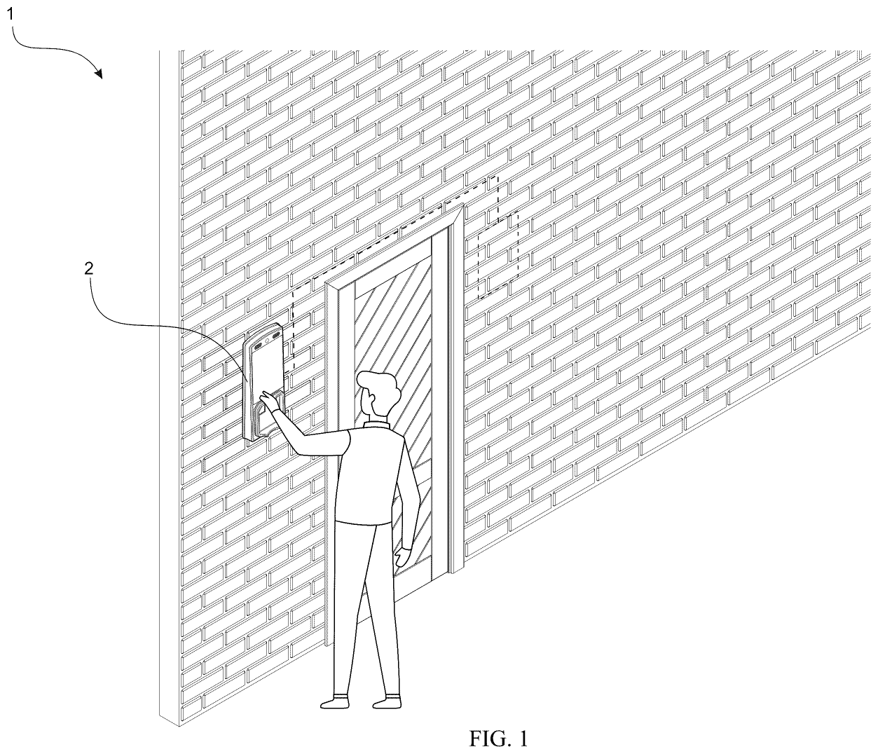

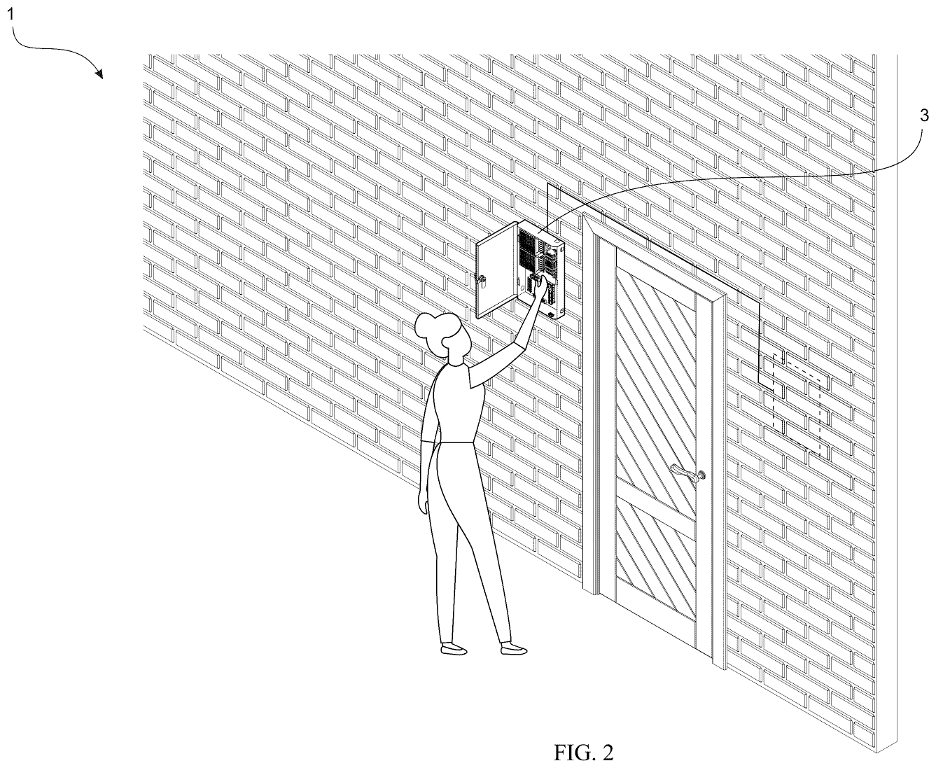

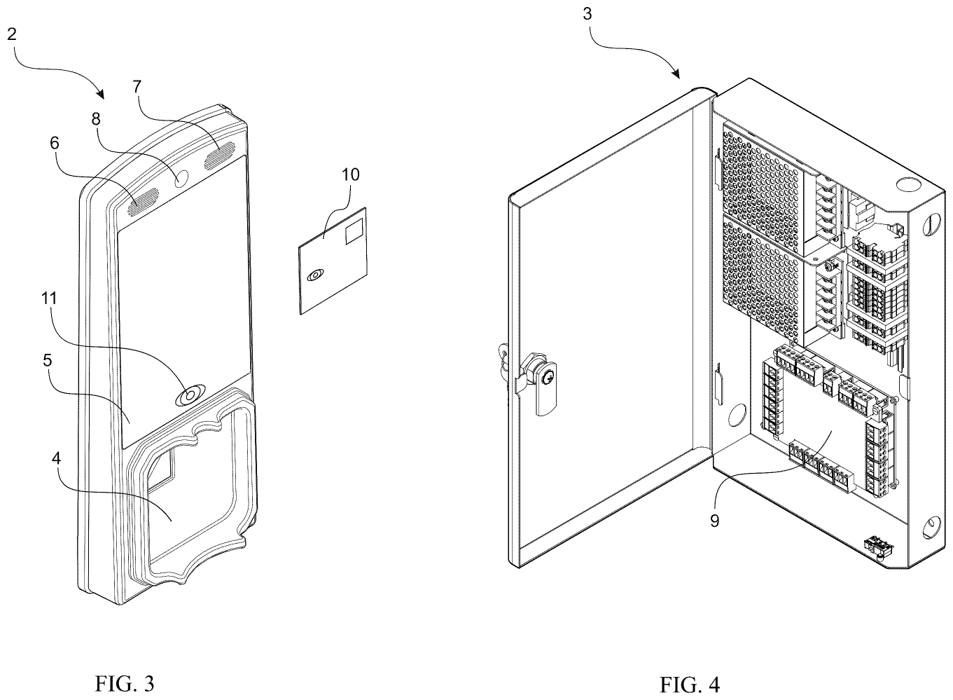

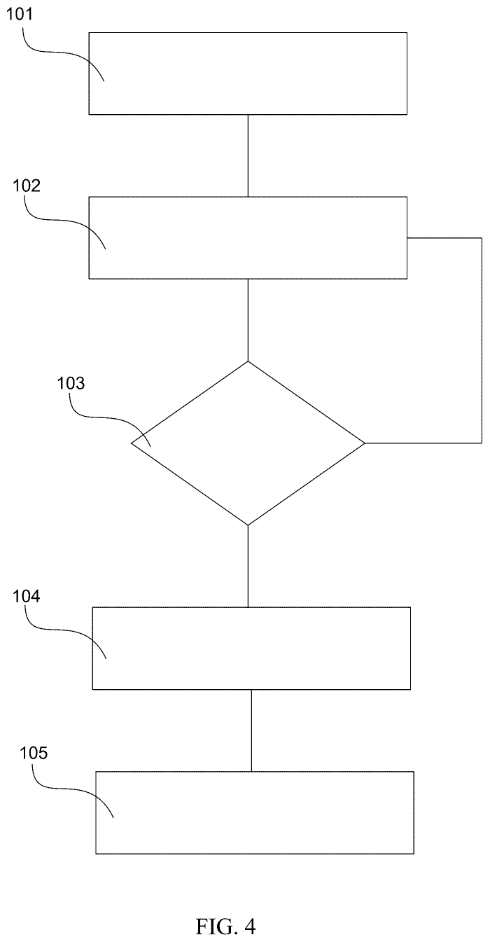

The elements shown in the figures are numbered and their corresponding numbers are as follows.
1. Safety system
2. Input module
3. Control module
4. Scanner
5. Screen
6. Speaker
7. Microphone
8. Camera
9. Controller
10. Card
11. Card reader

### DETAILED DESCRIPTION OF THE EMBODIMENTS

The invention basically consists of an input module (2) to be used for unlocking and a control module (3) that enables the door to be opened by verifying the data received through the input module (2). The input module (2) consists of a scanner (4), a display (5), a speaker (6), a microphone (7), and a camera (8). The control module (3) contains a controller (9).

The input module (2) was developed to perform the relevant input verification move of the user. The user enters the system with a password and/or card reading method entered through biological data and/or a virtual keyboard. There is a scanner (4) for performing palm and/or fingerprint scanning in the preferred embodiment of the invention. However, other authentication methods may also be preferred depending on the usage infrastructure. In this way, the user's data is transmitted to the relevant control module (3).

There is a screen (5) on the input module (2) so that users can act according to the relevant instructions during use. In addition, there is a speaker (6), a microphone (7), and a camera (8) in order to communicate with the person requesting access both autonomously and interactively. In addition, the speaker (6) may also be used for verbal notification of the relevant instructions to the user.

All sub-modules on the input module (2) have been determined in accordance with the purpose of use in the preferred application of the invention. In the changes to be made in the field of use, the relevant sub-modules can be increased in number and capability.

The input module (2) and/or the control module (3) have a controller (9) and the power and communication units required by the controller (9). The controller (9) checks the accuracy of the password, card, or biometric unlock data. The verification of the user can be done with a controller (9) to be added to the input module (2) or on the controller (9) on the control module (3).

The input module (2) and the control module (3) communicate with each other in encrypted form. After the pairing and installation of the two modules are completed, encrypted communication is provided with each other. If the opening data itself, which allows the user to be allowed access, is resolved in the input module (2), the instruction to open the lock will be sent to the control module (3) in encrypted form. If the power-on data that will allow the user access is solved in the control module (3), the input module (2) will only collect the password, card, or biometric data and transmit these data to the control module (3) in encrypted form.

Whether the control module (3) decides to open the door/lock itself or receives the instruction to open the door/lock by the instruction of the input module (2), communication between the two units is provided in encrypted form. In this way, even if the input module (2) in the unsecured area is broken by physical intervention, there will be no risk of opening the door/lock since it does not directly access the door/lock and performs all communication in encrypted form between the control module (3). The control module (3), on the other hand, generates the direct current and voltage required to unlock the door/lock in the secure area and transmits it to the door/lock in the secure area.

The encrypted communication between the input module (2) and the control module (3) is provided by a common communication protocol that they determine between the two units after the first introduction/matching. With this communication protocol created during the first match, the communication password will be periodically changed (for example, every 10 minutes) to ensure that only a communication known by two units and close to impossible to break is established between the two devices.

The use of any of the input modules (2) standing in the unsecured area or the control module (3) standing in the secure area for the initial matching and the subsequent removal of the matching poses a risk for the establishment or removal of the matching alone. For this reason, the two units will be matched with the authorized access at the same time, or the matching will be removed. Matchmaking will be completed with simultaneous approval of both operators to match and synchronize both devices. Similarly, the matching of the input module (2) and the control module (3) can be terminated by the simultaneous approval of the two operators. Controls for authorized access may require a password, card, or biometric authentication in the control module (3) as in the input module (2).

The steps of the operating algorithm of the safety system (1) are as follows:
(101) Relevant instructions are communicated to users
(102) The user enters the data
(103) Data entered by users are analyzed
(104) Login is verified
(105) Login is allowed within the user authorization.

The relevant instructions are first notified to the user during the use of the safety system (1) (101). The user can receive the relevant instructions in visual, auditory, and/or written form. According to these instructions, the user enters data into the system (102). The data entered may be biometric data, a password, a card, a QR and/or a barcode, and/or a mobile device belonging to the user. If the controller (9) is on the input module (2), the access authorization of the users is examined through the controller (9) in the input module (2) (103). If the authorized user is detected, the login is verified (104). The door/unlock instruction is transmitted encrypted to the control module (3). The control module (3) allows the user access if it detects that the encrypted data received by it is the data that allows the door to be opened (105).

In case the controller (9) is located in the control module (3) instead of the input module (2), the user's unlock data is sent to the control module (3) from the input module (2) in encrypted form. The control module (3) decrypts the encrypted data received and performs the user's input verification through the controller (9) (104). If the user has the authority to open the door/lock, it opens the door and allows the user access (105).

In the event that it decides that the person accessing the system is not authorized to access, relevant warnings are issued to the user requesting access permission.

What is claimed is:

1. A safety system, comprising: an input module, a controller and a control module, wherein a first operator in the control module in a secure area and a second operator in the input module in an unsecured area simultaneously confirm a first pairing to initiate encrypted communication between the first operator and the second operator in order to transmit an instruction to open a door/lock in an encrypted form; wherein
the input module is located in the unsecured area for a purpose of performing a relevant input verification move of a user;
the controller is located on the input module, wherein the input module checks an accuracy of password, card, or biometric unlocking data;
the control module is located in the secure area enabling the door/lock to be unlocked; and
the safety system is configured to check in users while the users are in the unsecured area during access to secure rooms/areas and unlock the users from the secure area.

2. The safety system according to claim 1, wherein an authenticity of the password, card or biometric unlocking data is checked by the controller located on the control module instead of the input module.

3. The safety system according to claim 1, wherein the input module transmits an unlocking instruction to the control module in the encrypted form, if the password, card, or biometric unlocking data is decoded in the input module, allowing access to be granted to the user.

4. The safety system according to claim 2, wherein the input module collects password, card, or biometric data and transmits these data to the control module in the encrypted form, if opening data to allow access to the user is to be decrypted in the control module.

5. The safety system according to claim 1, wherein the control module generates a direct current and voltage required to release the door/lock in the secure area and transmits the direct current and voltage to the door/lock in the secure area.

6. The safety system according to claim 1, wherein the input module and the control module that the first operator and the second operator simultaneously approve, the first operator in the control module in the secure area and the second operator in the input module in the unsecured area, in order to unpair the first paired input module and control module.

7. The safety system according to claim 1, wherein the first operator and the second operator have access to the input module and the control module by password, card, or biometric authentication in order to be able to pair and unpair.

8. The safety system according to claim 2, wherein the control module generates a direct current and voltage required to release the door/lock in the secure area and transmits the direct current and voltage to the door/lock in the secure area.

9. The safety system according to claim 3, wherein the control module generates a direct current and voltage required to release the door/lock in the secure area and transmits the direct current and voltage to the door/lock in the secure area.

10. The safety system according to claim 4, wherein the control module generates a direct current and voltage required to release the door/lock in the secure area and transmits the direct current and voltage to the door/lock in the secure area.

11. The safety system according to claim 2, wherein the input module and the control module that the first operator and the second operator simultaneously approve, the first operator in the control module in the secure area and the second operator in the input module in the unsecured area, in order to unpair the first paired input module and control module.

12. The safety system according to claim 3, wherein the input module and the control module that the first operator and the second operator simultaneously approve, the first operator in the control module in the secure area and the second operator in the input module in the unsecured area, in order to unpair the first paired input module and control module.

13. The safety system according to claim 4, wherein the input module and the control module that the first operator and the second operator simultaneously approve, the first operator in the control module in the secure area and the second operator in the input module in the unsecured area, in order to unpair the first paired input module and control module.

14. The safety system according to claim 5, wherein the input module and the control module that the first operator and the second operator simultaneously approve, the first operator in the control module in the secure area and the second operator in the input module in the unsecured area, in order to unpair the first paired input module and control module.

15. The safety system according to claim 2, wherein the first operator and the second operator have access to the input module and the control module by password, card, or biometric authentication in order to be able to pair and unpair.

16. The safety system according to claim 3, wherein the first operator and the second operator have access to the input module and the control module by password, card, or biometric authentication in order to be able to pair and unpair.

17. The safety system according to claim 4, wherein the first operator and the second operator have access to the input module and the control module by password, card, or biometric authentication in order to be able to pair and unpair.

18. The safety system according to claim 5, wherein the first operator and the second operator have access to the input module and the control module by password, card, or biometric authentication in order to be able to pair and unpair.

19. The safety system according to claim 6, wherein the first operator and the second operator have access to the input module and the control module by password, card, or biometric authentication in order to be able to pair and unpair.
